(19) United States
(12) Patent Application Publication
(10) Pub. No.: US 2014/0084746 A1
(43) Pub. Date: Mar. 27, 2014

(54) DC COMMUTATOR MOTOR AND AUXILIARY MACHINE FOR MOTOR VEHICLE USING THE SAME

(71) Applicant: Hitachi Automotive Systems, Ltd., Hitachinaka-shi (JP)

(72) Inventors: Tsukasa TANIGUCHI, Hitachinaka (JP); Hidefumi IWAKI, Hitachinaka (JP); Kenji KUNIYA, Hitachinaka (JP); Daisuke NOZAKI, Hitachinaka (JP); Toshikazu SAGAWA, Hitachinaka (JP)

(73) Assignee: Hitachi Automotive Systems, Ltd., Hitachinaka-shi (JP)

(21) Appl. No.: 13/961,220

(22) Filed: Aug. 7, 2013

(30) Foreign Application Priority Data
Sep. 27, 2012 (JP) 2012-213380

(51) Int. Cl. H01R 39/16

(52) U.S. Cl. CPC H01R 39/16
USPC 310/235

(57) ABSTRACT

DC commutator motor that prevents variation in characteristics of the motor and suppressing deterioration of performance, and reduces the number of assembly steps. A magnet is attached to an inner circumferential surface of a bottomed cylindrical bracket to form a field pole. In an armature, a commutator is fastened to an armature core which is formed by laminating a plurality of thin core sheets. Shaft is inserted into the integrated body of the armature core with the commutator. Armature coil is wound within slots provided in the armature core, and bearings are attached. The armature is assembled with the field pole. Polygonal protruding portion which is made of resin is provided in the commutator, the protruding portion fastened to inner circumferential surfaces of the slots of the armature core, and the shaft is then inserted.

### BACKGROUND OF THE INVENTION

1. Field of the Invention

The present invention relates to a DC commutator motor that prevents variation in the characteristics of the motor and exhibits improved performance.

2. Description of the Related Art

In a DC commutator motor, continuous rotation torque is obtained while switching positive and negative of current (commutating) flowing in an armature coil by commutation effect of a brush with a commutator. Further, phase of current in the armature coil is affected by a relative position between an armature core and the commutator in a circumferential direction and a relative position between the brush and a field pole in the circumferential direction. Therefore, it is important to accurately assemble these components for preventing variation in the characteristics of the motor.

In particular, it is known that the larger the number of slots formed in the armature core is, the larger the number of commutator segments provided in the commutator is, and the larger the number of magnetic poles of the field pole, the more greatly the relative position between the armature core and the commutator in the circumferential direction affects the characteristics of the motor even with small position deviation.

As a method that is capable of improving assembly accuracy, there is a method described in Japanese Patent No. 3379892. In this method, through holes are provided in an armature core so as to penetrate the armature core in an axial direction thereof. A plurality of protruding portions which are combined with and fixed to the respective through holes are provided in a commutator. The protruding portions are passed through the respective through holes of the armature core, and fixed thereto.

### SUMMARY OF THE INVENTION

An assembly position of an armature core with a commutator in the circumferential direction affects phase of current in an armature coil. When the assembly position of the armature core with the commutator is inappropriate or has deviation, the phase of current in the armature coil changes from a normal current phase, which may cause variation in the characteristics of a motor and deterioration of the performance of the motor.

Especially, a ratio of the electrical angle to the mechanical angle in a DC commutator motor including four field poles (a four-pole DC commutator motor) is twice that in a DC commutator motor including two field poles (a two-pole DC commutator motor). Further, a ratio of the electrical angle to the mechanical angle in a DC commutator motor including six field poles (a six-pole DC commutator motor) increases to three times that in a DC commutator motor including two field pole (a two-pole DC commutator motor). Therefore, it is necessary to achieve higher assembly accuracy in the case of a multiple-pole DC commutator motor including four or more field poles.

In order to deal with such problems, there may be employed a method in which through holes are provided in an armature core, a plurality of protruding portions which are combined with and fixed to the respective through holes are provided in a commutator, and these protruding portions are passed through the respective through holes of the armature core and fixed thereto to thereby improve the assembly accuracy.

However, since the through holes are provided so as to penetrate the armature core in this method, a cross-sectional area through which a magnetic flux passes is reduced, and magnetic resistance is therefore increased, which may cause deterioration of the characteristics of the motor. In addition, since the protruding portions are made of metal, eddy current may flow into the protruding portions due to the change of a magnetic field caused by driving the motor, thereby causing Joule loss. As a result, output power of the motor may be reduced.

Therefore, it is a first object of the present invention to provide a high-quality DC commutator motor that is capable of preventing variation in the characteristics of the motor and suppressing deterioration of the performance of the motor by improving assembly accuracy of an armature core with a commutator.

In order to solve the above problems, a DC commutator motor according to the present invention includes a yoke, a field magnet arranged on an inner circumference of the yoke, and an armature unit rotatably supported at an inner circumferential side of the field magnet. The armature unit includes an armature core having a plurality of armature slots formed on an outer circumference thereof and a coil wound within the armature slots, a shaft arranged on a central axis of the armature core, and a commutator unit arranged in a circumferential direction of the shaft. Further, an outer circumference of the commutator unit is fitted into a concave portion formed in the armature core to fix the commutator unit to the armature core in a circumferential direction.

Since the commutator is fastened to the armature core by using an area in which the flow of a magnetic flux of the armature core is not blocked, deterioration of the characteristics of the motor is not caused. Further, it is possible to accurately position the armature core with the commutator, thereby producing an effect of preventing variation in the characteristics of the motor.

### BRIEF DESCRIPTION OF THE DRAWINGS

FIG. 1 is a cross-sectional side view of a DC commutator motor according to a first embodiment of the present invention;

FIGS. 2A and 2B are cross-sectional views of armature core sheets;

FIG. 3A is a perspective view and FIG. 3B is a cross-sectional side view of an armature core;

FIG. 4A is a perspective view and FIG. 4B is a cross-sectional side view of a commutator unit;

FIG. 5 is a diagram illustrating an assembled state of a shaft, the commutator unit, and the armature core;

FIG. 6 is a diagram illustrating a combined state of the armature core with the commutator unit;

FIG. 7 is a perspective view illustrating a completely assembled state of the shaft, the commutator unit, and the armature core;

FIG. 8 is a cross-sectional side view of a DC commutator motor according to a second embodiment of the present invention; and

FIG. 9 is a cross-sectional side view of a DC commutator motor according to a third embodiment of the present invention.

### DESCRIPTION OF THE PREFERRED EMBODIMENTS

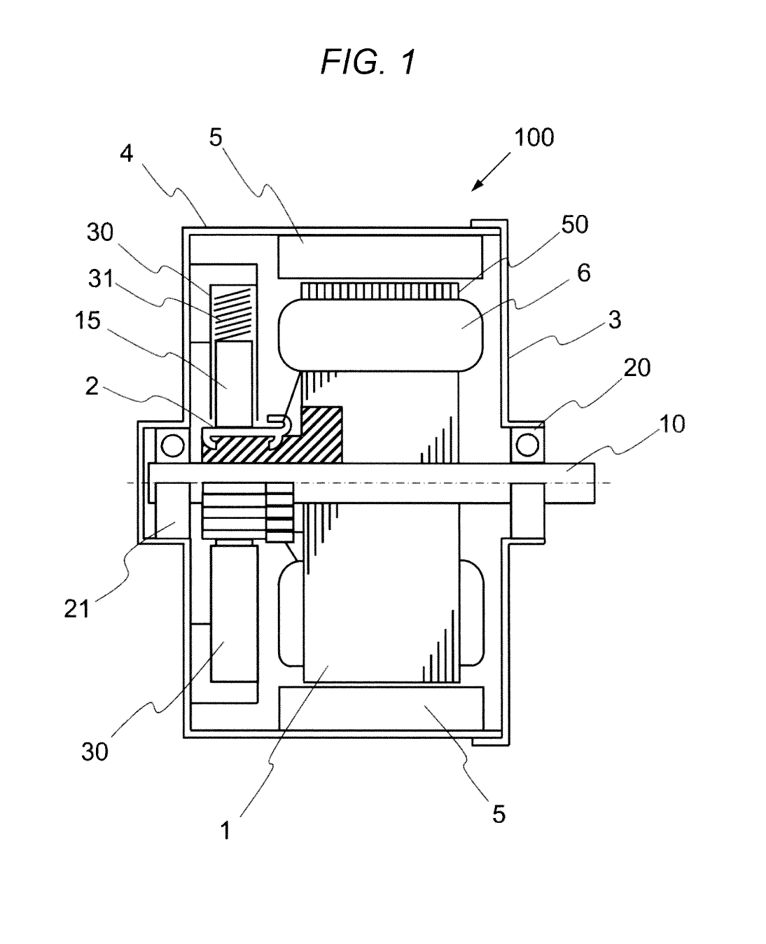

Hereinafter, a first embodiment of the present invention will be described with reference to FIGS. 1 to 7. A DC commutator motor of the first embodiment is used, for example, in a hydraulic pump of a vehicle. First, the configuration of the DC commutator motor will be described with reference to FIG. 1. FIG. 1 is a cross-sectional side view of the DC commutator motor according to the first embodiment of the present invention.

A DC commutator motor 100 includes a yoke 4, a front bracket 3, a field magnet 5, and an armature (rotor) 1. The yoke 4 has a bottomed, generally cylindrical shape, and includes a rear bearing 21 and a brush holder 30. The rear bearing 21 is arranged in a central part of an end face of the yoke 4, and rotatably supports one end of a shaft 10.

The front bracket 3 is generally disc-shaped, and includes a front bearing 20. The front bracket 3 is arranged in an end of the yoke 4. The brush holder 30 holds a brush 15. A brush pressurizing spring 31 is arranged between the brush holder 30 and the brush 15. The brush 15 is biased toward a commutator unit 2 by elastic force of the brush pressurizing spring 31 (an elastic body). Accordingly, the brush 15 supplies electric power which is supplied from the outside to an armature coil 6 through the commutator unit 2. The front bearing 20 is arranged in a central part of the front bracket 3, and rotatably supports the other end of the shaft 10. The field magnet 5 (stator) is arranged on an inner circumferential surface of the yoke 4, and generates a magnetic field. The armature 1 has a generally columnar shape, and includes an armature core 50, the commutator unit 2, the shaft 10, and the armature coil 6. The armature core 50 is formed by laminating generally disc-shaped steel sheets (core sheets). The shaft 10 is arranged on a central axis of the armature 1, and rotatably supported by the front bearing 20 and the rear bearing 21. The outer diameter of the armature 1 is smaller than the inner diameter of the field magnet 5. Accordingly, the armature 1 is rotatably supported with a space between the armature 1 and an inner circumferential side of the field magnet 5. The armature coil 6 is wound within armature slots 71 which are formed on an outer circumference of the armature core 50.

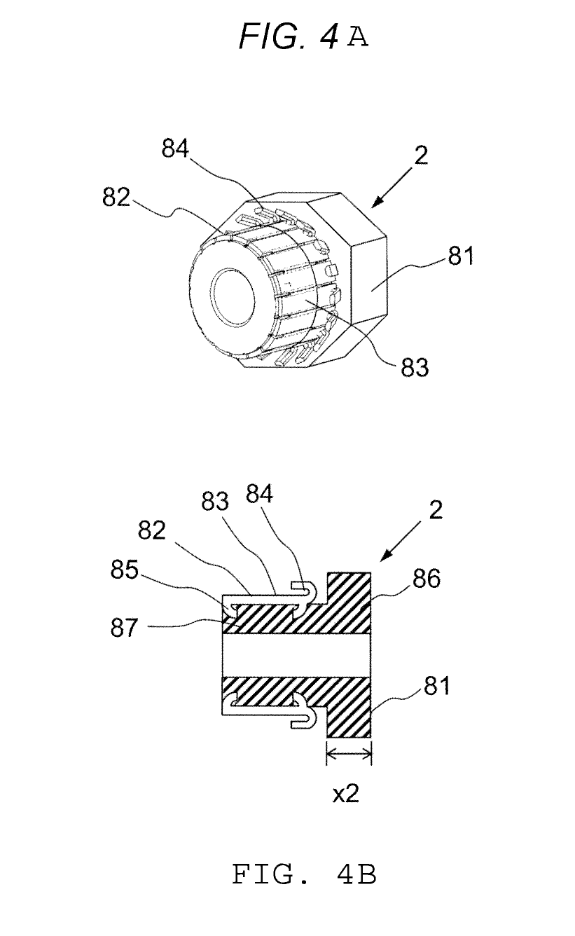

The commutator unit 2 is arranged in a part of the shaft 10, and supplies electric power which is supplied from the outside to the armature coil 6. The configuration of the commutator unit 2 will be described in detail later with reference to FIG. 4. A resin portion 81 of the commutator unit 2 protrudes toward the armature core 50. The thus protruding portion and the armature core 50 are fastened to each other.

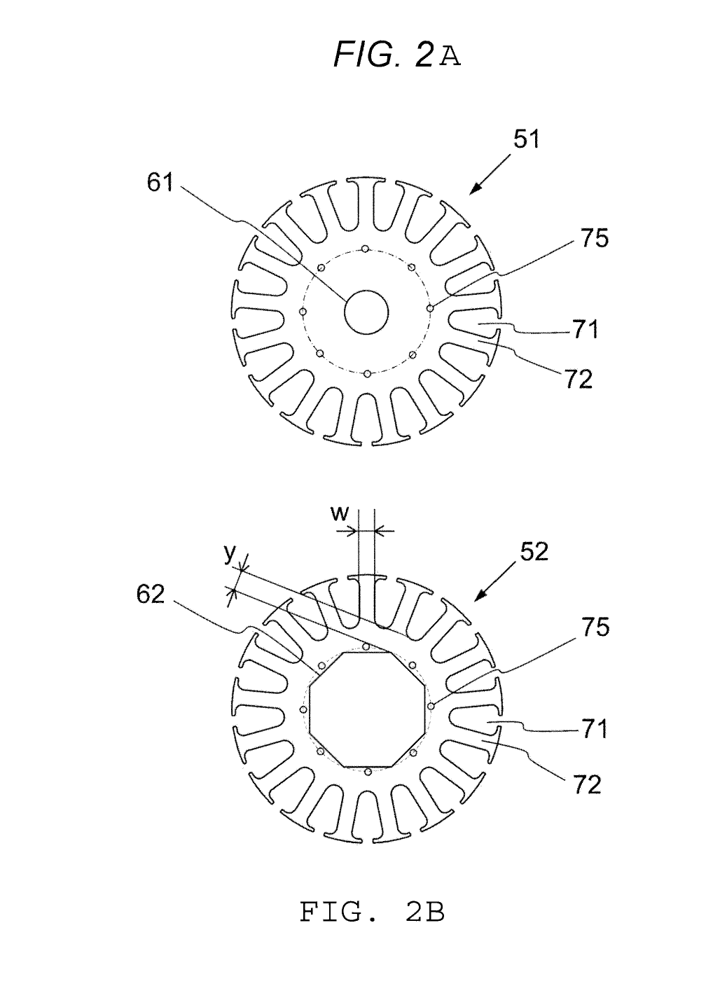

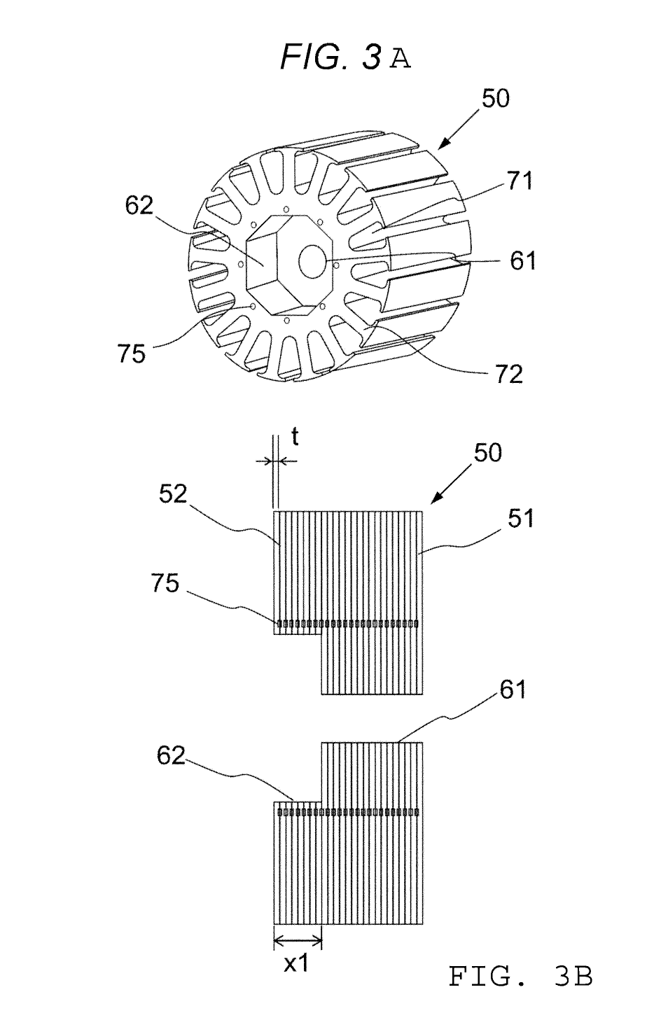

Next, the configuration of the armature core 50 of the DC commutator motor 100 shown in FIG. 1 will be described in detail with reference to FIGS. 2 and 3.

FIG. 2 are cross-sectional views of an armature core sheet (A) 51 and an armature core sheet (B) 52 which constitute the armature core 50 when viewed from the axial direction.

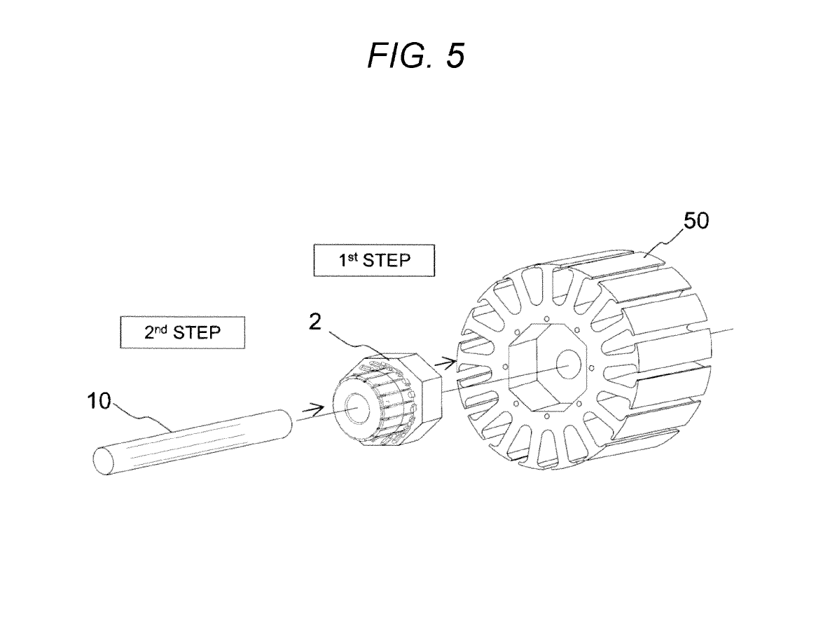

First, the armature core sheet (A) 51 will be described. Each of the armature slots 71 is formed between adjacent two of armature teeth 72. More specifically, the armature slots 71 are formed (arranged) on an outer circumference of the armature core sheet (A) 51 at equal intervals. Further, a fastening portion (A) 61 is formed in a central part of the armature core sheet (A) 51. The shaft 10 is fastened to the fastening portion (A) 61. The fastening of the shaft 10 to the fastening portion (A) 61 will be described in detail later with reference to FIG. 5. Further, core fastening portions 75 for fixing the armature core sheets to each other are radially arranged in the armature core sheet (A) 51 at equal intervals. The core fastening portions 75 are arranged along an arc connecting vertices of a regular octagon which is the shape of a fastening portion (B) 62 of the armature core sheet (B) 52 on the inner circumferential side. The positions of the core fastening portions 75 that are arranged in the armature core sheet (A) 51 and the positions of core fastening portions that are arranged in the armature core sheet (B) are made to correspond to each other when the armature core sheets (A) 51 and (B) 52 are laminated in a thickness direction of the core sheets. The core fastening portions 75 are formed by forming concavities and convexities on the armature core sheets by processing, and these concavities and convexities are connected by caulking to thereby fix the armature core sheets to each other.

Next, the armature core sheet (B) 52 will be described. The outer size and the shapes of armature teeth 72 and armature slots 71 are the same as those of the armature core sheet (A) 51. A difference of the armature core sheet (B) 52 from the armature core sheet (A) 51 is the shape of an inner circumference thereof. The inner circumferential surface of the armature core sheet (A) 51 has a circular shape. On the other hand, as shown in FIG. 2, the inner circumference of the armature core sheet (B) 52 has a regular octagonal shape which is arranged in the center of the armature core sheet (B) 52. Further, the outer shape and the size of the regular octagon are made to be the same as those of the cross section of the protruding portion of the commutator unit 2 which will be described later and also within a range that does not affect the flow of a magnetic flux. Specifically, when a size y of a core back part of the armature core 50 shown in FIG. 2 is equal to or larger than a width w of each of the armature core teeth 72, a magnetic flux flows smoothly, and the characteristics of the motor is therefore not deteriorated. Therefore, the outer shape and the size of the regular octagon may be set so as to satisfy this condition. Further, thicknesses t of the armature core sheet (A) 51 and the armature core sheet (B) 52 may not necessarily be the same as each other.

FIG. 3 are a perspective view and cross-sectional views of the armature core 50, the cross-sectional views being viewed from the axial direction. A predetermined number of armature core sheets (A) 51 and a predetermined number of armature core sheets (B) 52 are combined and laminated on each other so that the armature core 50 has a predetermined laminated thickness (the length of the armature core 50 in the axial direction thereof), and the armature core sheets (A) 51 and the armature core sheets (B) 52 are fixed to each other by using the core fastening portions 75 to thereby constitute the armature core 50. In FIGS. 3 and 4, an axial direction length X1 of the fastening portion (B) 62 is the same as an axial direction length X2 of a protruding portion 86 of the commutator unit 2. That is, an end surface of the protruding portion 86 of the commutator unit 2 comes into contact with an end surface of the fastening portion (B) 62 of the armature core 50, the end surface being positioned in the axial direction. As a result, it is possible to accurately set the positions of the commutator unit 2 and the armature core 50 in the axial direction.

FIG. 4 are a perspective view and a cross-sectional view of the commutator unit 2, the cross-sectional view being viewed from the axial direction. The commutator unit 2 is composed of commutator segments 82 which are made of, for example, copper and the resin portion 81 which is made of heat-resistant resin such as phenol resin. Each of the commutator segments 82 includes a hook 84 on which a conductor of the armature coil 6 is hooked, a sliding contact portion 83 with which the brush 15 makes sliding contact, an anchor 85 which is firmly fixed to the resin portion 81 so that each of the commutator segments 82 does not come off the resin portion 81 due to centrifugal force by rotation. The commutator segments 82 are equally arranged in the circumferential direction of the commutator unit 2. The resin portion 81 includes an embedding portion 87 in which the anchor 85 of the each of the commutator segments 82 is embedded and the protruding portion 86 which is inserted into and fixed to the fastening portion (B) 62 of the armature core 50. These portions are produced so as to have an integral structure by embedding them in resin together with the commutator segments 82. The protruding portion 86 is formed to have a regular octagonal cross section so as to be combined with the regular octagonal fastening portion (B) 62 of the armature core 50 without any space therebetween.

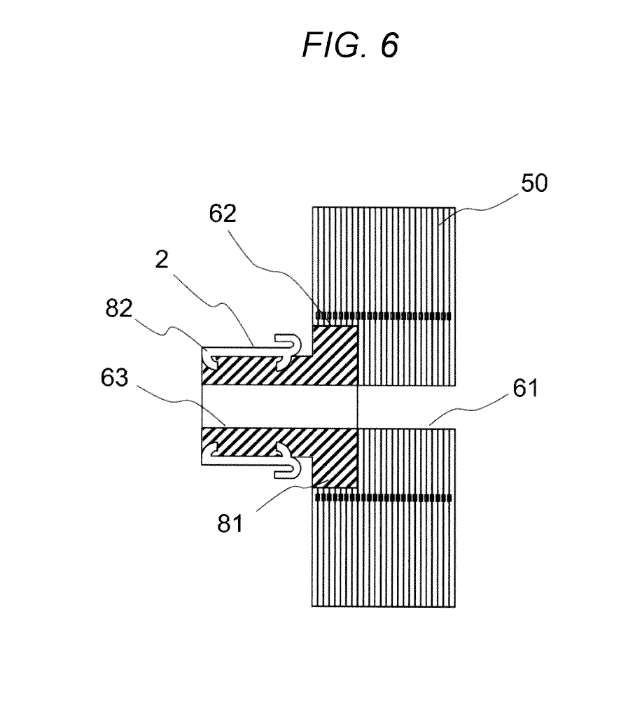

FIG. 5 schematically illustrates assembly steps of the armature core 50 before winding the armature coil 6 around the armature core 50. In a first step of an assembly process, the commutator unit 2 is assembled with the armature core 50. The thus assembled state of the commutator unit 2 with the armature core 50 will be described with reference to FIG. 6. The protruding portion 86 of the commutator unit 2 is fastened to the fastening portion (B) 62 of the armature core 50. The fixing method may be selected from press-fitting, bonding, and the like depending on the purpose.

In the first step, two steps including accurately setting the positions of the armature core 50 and the commutator unit 2 in the circumferential direction and integrally constructing the armature core 50 with the commutator unit 2 are performed at the same time.

Next, in a second step of the assembly process, the shaft 10 is inserted into the center of an axis of an integrated body of the armature core 50 with the commutator unit 2, the integrated body being produced in the first step. The fastening of the shaft 10 to the integrated body is performed at the fastening portion (A) 61 of the armature core 50 and the fastening portion (C) 63 of the commutator unit 2. Tiny protrusions protruding in the axial direction are formed on the shaft 10 at several locations in the circumferential direction thereof (details thereof are not shown). These protrusions are fastened to the fastening portion (A) 61 and the fastening portion (C) 63 so that the shaft 10 is fixed to the armature core 50 and the commutator unit 2 by meshing in the axial direction. As a result, rotation torque is transmitted to the outside through an output shaft.

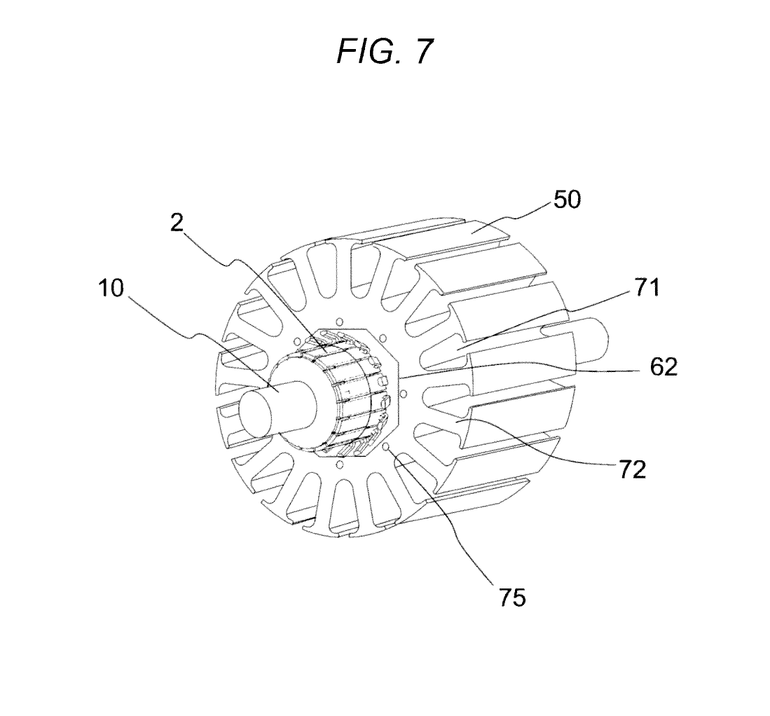

FIG. 7 is a perspective view illustrating a completely assembled state of the shaft 10, the commutator unit 2, and the armature core 50. The shaft 10, the commutator unit 2, and the armature core 50 after the completion of the assembly are fastened to and integrated with each other.

The armature coil 6 is wound within the armature slots 71 of the armature core 50 at a predetermined slot pitch while hooking the armature coil 6 on the hooks 84 of the commutator unit 2 to produce the armature 1. By attaching the front bearing 20 and the rear bearing 21 to the armature 1 from both ends of the shaft 10, the armature 1 becomes rotatable. Thereafter, the armature 1 is housed in the yoke 4 to which the field magnet 5 is attached, and the front bracket 3 is then assembled thereto to produce the DC commutator motor 100. Although each of the inner circumferential surface of the armature core sheet (B) 52 and the protruding portion 86 provided in the commutator unit 2 has a regular octagonal cross-sectional shape, the cross-sectional shapes are not limited thereto. The cross-sectional shapes of the inner circumferential surface of the armature core sheet (B) 52 and the protruding portion 86 of the commutator unit 2 may be other polygonal shapes or other shapes as long as the effect of the present invention is achieved.

In a conventional armature, it is necessary to perform an assembly operation in the following assembly order. A shaft is first inserted into an armature core. Thereafter, a relative position between the armature core into which the shaft has been inserted and a commutator is set using a special tool. As a result, the number of steps required for the assembly tends to be increased.

In view of the above, in the present embodiment, a magnet is attached to an inner circumferential surface of a bottomed cylindrical bracket to form a field pole. In an armature, a commutator is fastened to an armature core which is formed by laminating a plurality of core sheets (steel sheets). Thereafter, a shaft is inserted into the thus integrated body of the armature core with the commutator. Then, an armature coil is wound within slots provided in the armature core, and bearings are attached thereto to thereby form the armature. The armature is assembled with the field pole. In the fastening of the commutator to the armature core, a polygonal protruding portion which is made of resin is provided in the commutator, the protruding portion is fastened to inner circumferential surfaces of the slots of the armature core, and the shaft is then inserted thereinto.

With such a configuration, it is possible to previously assemble the commutator with the armature core, and then insert the shaft thereinto. Therefore, it is possible to reduce the number of steps required for the assembly compared to a conventional assembly method in which an armature core and a commutator are separately assembled with a shaft, thereby making it possible to provide a DC commutator motor at a low cost.

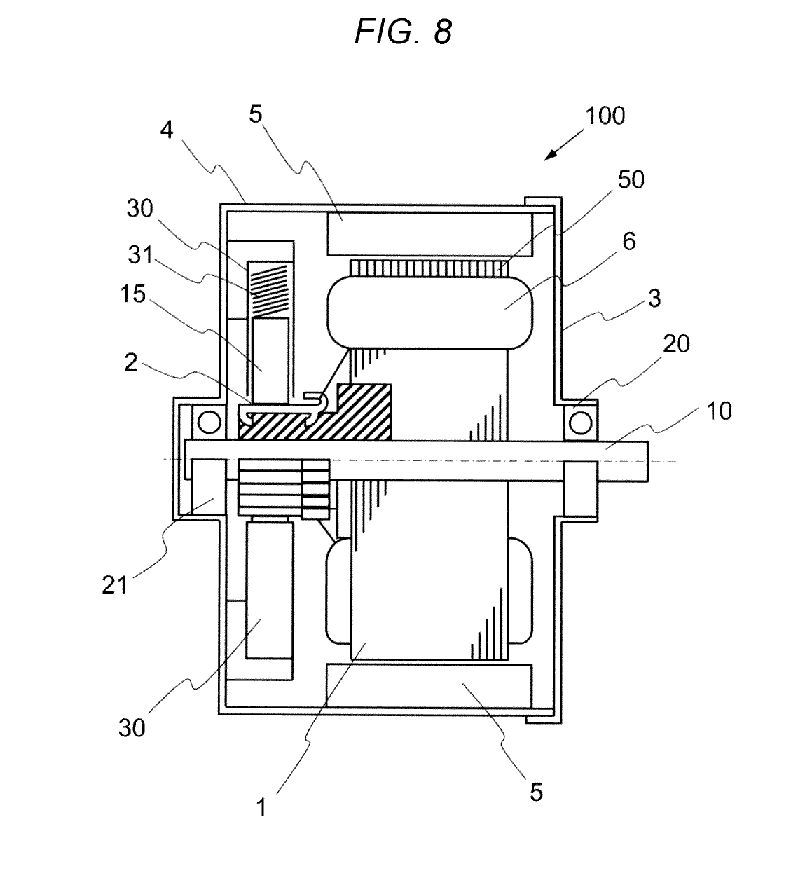

FIG. 8 is a cross-sectional side view of a DC commutator motor according to a second embodiment of the present invention. In FIG. 8, an axial direction length X1 of a fastening portion (B) 62 provided in an armature core 50 is set to be shorter than an axial direction length X2 of a protruding portion 86 of a commutator unit 2. That is, an end surface of the protruding portion 86 of the commutator unit 2, the end surface not facing the armature core 50, is arranged exterior to the armature core 50. Accordingly, distances between hooks 84 arranged in the commutator unit 2 and armature slots 71 are made longer, and a creeping distance can therefore be extended. Therefore, the second embodiment is preferred when the terminal voltage of the motor is high.

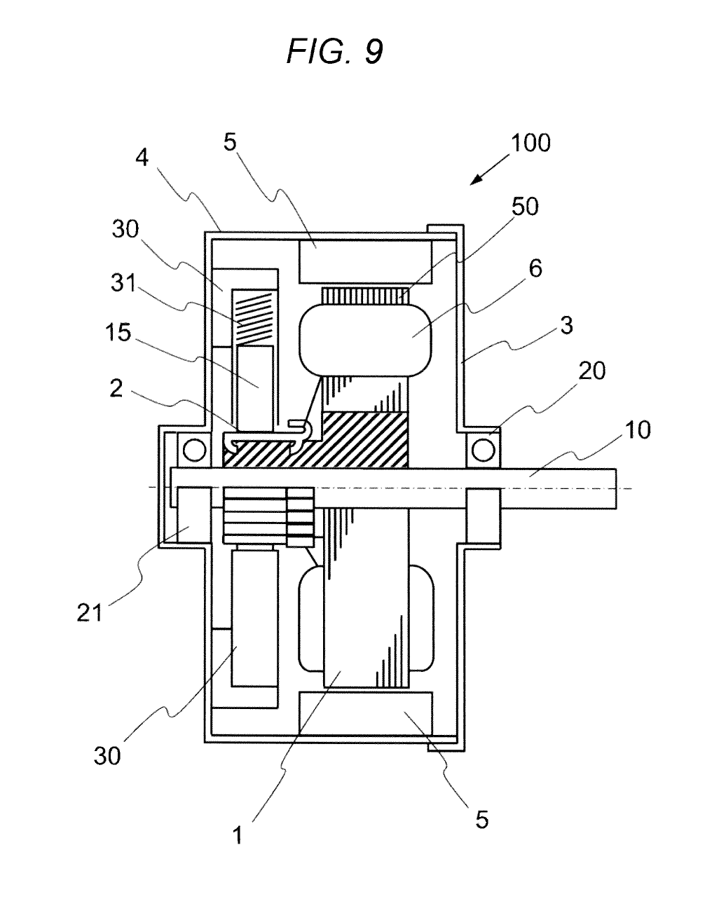

FIG. 9 is a cross-sectional side view of a DC commutator motor according to a third embodiment of the present invention. In the third embodiment of the present invention, only armature core sheets (B) 52 are used as armature core sheets constituting an armature core 50. Accordingly, an inner circumferential surface of the armature core 50 is composed only of a fastening portion (B) 62. An axial direction length X1 of the fastening portion (B) 62 provided in the armature core 50 is made to be the same as an axial direction length X2 of a protruding portion 86 of a commutator unit 2. The third embodiment is preferably employed when the axial direction length X2 of the protruding portion 86 of the commutator unit 2 cannot be sufficiently ensured, such as a case where the armature core 50 is flat (the outer diameter of the armature core 50 is large relative to the axial direction length thereof).

### REFERENCE SIGNS LIST

1 armature
2 commutator unit
3 front bracket
4 yoke
5 field magnet
6 armature coil
10 shaft
15 brush
20 front bearing
21 rear bearing
30 brush holder
31 brush pressurizing spring
50 armature core
51 armature core sheet (A)
52 armature core sheet (B)
61 fastening portion (A)
62 fastening portion (B)
63 fastening portion (C)
71 armature slot
72 armature teeth
75 core fastening portion
81 resin portion
82 commutator segment
83 sliding contact portion
84 hook
85 anchor
86 protruding portion
87 embedding portion
100 DC commutator motor

What is claimed is:

1. A DC commutator motor comprising:
a yoke;
a field magnet arranged on an inner circumference of the yoke; and
an armature unit rotatably supported at an inner circumferential side of the field magnet, the armature unit including
an armature core having a plurality of armature slots formed on an outer circumference thereof and a coil wound within the armature slots,
a shaft arranged on a central axis of the armature core, and
a commutator unit arranged in a circumferential direction of the shaft,
wherein an outer circumference of the commutator unit is fitted into a concave portion formed in the armature core to fix the commutator unit to the armature core in a circumferential direction.

2. The DC commutator motor according to claim 1, wherein a protruding portion is provided on the outer circumference of the commutator unit, and the protruding portion is fitted into the concave portion.

3. The DC commutator motor according to claim 2, wherein the protruding portion has a polygonal shape.

4. The DC commutator motor according to claim 3, wherein the protruding portion is made of resin.

5. The DC commutator motor according to claim 2, wherein the armature core is constituted by laminating at least first core sheets each having a first shape and second core sheets each having a second shape, an inner circumference of each of the first core sheets is larger than an inner circumference of each of the second core sheets, and a shape of an inner circumference of the first core sheets in an laminated state corresponds to a cross-sectional shape of the protruding portion.

6. The DC commutator motor according to claim 2, wherein a size, in a radial direction, of the protruding portion is set to be larger than a size, in the radial direction, of a part of the commutator unit including hooks after connecting the coil thereto, the part excepting the protruding portion.

7. The DC commutator motor according to claim 5, wherein the first core sheets and the second core sheets are fixed to each other using fastening portions provided in each of the first core sheets and the second core sheets, the fastening portions are formed by performing plastic working on the first core sheets and the second core sheets, and the fastening portions are arranged on an arc connecting vertices of a polygon forming an inner circumference surface of each of the first core sheets.

8. The DC commutator motor according to claim 1, wherein the number of poles of the field magnet is four or more.
